(19) United States
(12) Patent Application Publication
(10) Pub. No.: US 2026/0278401 A1
(43) Pub. Date: Sep. 17, 2026

(54) SYSTEMS AND METHODS FOR AUTOMATIC EVALUATION, MONITORING, AND ROOT CAUSE ANALYSIS FOR GENERATIVE ARTIFICIAL INTELLIGENCE APPLICATIONS

(71) Applicant: NVIDIA Corporation, Santa Clara, CA (US)

(72) Inventors: Aaditya Ramshankar SHUKLA, Fremont, CA (US); Yang JIAO, Mountain View, CA (US); Tony Wijaya SALIM, Santa Clara, CA (US); Abhinav BALASUBRAMANIAN, Milpitas, CA (US); Paramaguru MUTHUSAMY, Fremont, CA (US); Shivakesh Reddy ANNEPALLY, San Ramon, CA (US); Rama Kalyani Tirumala AKKIRAJU, Cupertino, CA (US); Deepak BORA, San Roman, CA (US); Anbang XU, San Jose, CA (US)

(21) Appl. No.: 19/078,729

(22) Filed: Mar. 13, 2025

(51) Int. Cl. G06N 3/10; G06N 3/0475

(52) U.S. Cl. CPC G06N 3/10; G06N 3/0475

(57) ABSTRACT

In various examples, systems and methods are provided for automatic evaluation, monitoring, and root cause analysis for generative AI applications. Quality metric(s) may be generated for a generative AI application based at least on output(s) of the generative AI application during evaluation. Log(s) for component(s) of the generative AI application may be generated during evaluation and comprise data flow, processing steps, and performance metric(s) associated with the generative AI application. Indication(s) of a root cause of a regression for the generative AI application may be generated using model(s) based at least on the quality metric(s) for the generative AI application and the log(s) for the component(s) of the generative AI application. Operation(s) for addressing the regression for the generative AI application may be performed based at least on the indication(s) of the root cause of the regression for the generative AI application.

### BACKGROUND

The rapid advancements in generative AI have led to an increased demand for generative AI applications across various industries and teams. Some of these applications (e.g., domain-specific Q&A chatbots) may be designed to provide accurate and relevant responses to user queries and may leverage, for example, large language models (LLMs) and retrieval-augmented generation (RAG) systems. The architecture for a generative AI application typically includes numerous components that may be tuned to adapt the operation and overall performance of the application. The developer(s) of the generative AI application need to thoroughly understand the components and the operation/interaction of the components in order to improve performance (e.g., accuracy, latency, etc.) and maintain that performance in a production environment.

### SUMMARY

Embodiments of the present disclosure relate to automatic evaluation, monitoring, and root cause analysis for generative AI applications. Systems and methods are disclosed that may be used for, among other things, detecting regressions for generative AI applications and generating reports that may identify root causes for regressions for generative AI applications and provide proposed actions to address the regressions for the generative AI applications.

In contrast to conventional systems, the systems and methods presented in this disclosure may utilize advanced evaluation and monitoring techniques to enhance or maintain the performance of generative AI applications. The evaluation and monitoring techniques may include generating quality metric(s) for the outputs produced by the generative AI application and logging data flow, processing steps, and performance metric(s) associated with the generative AI application. Root cause analysis may be performed (e.g., using one or more models) and one or more indications of a root cause of a regression for the generative AI application may be generated based at least on the quality metric(s) and log(s). In some embodiments, the evaluation and monitoring may further include receiving recent configuration changes (e.g., to the source code, parameters, settings, etc.) made for the generative AI application, and the root cause analysis generated using the model(s) may provide further insight and actionable steps for addressing a regression for the generative AI application based on the configuration changes.

### BRIEF DESCRIPTION OF THE DRAWINGS

The present systems and methods for automatic evaluation, monitoring, and root cause analysis for generative AI applications are described in detail below with reference to the attached drawing figures, wherein:

FIG. 1 is an illustration of an example data flow diagram for an evaluation and monitoring operating environment suitable for use in implementing some embodiments of the present disclosure;

FIG. 2 is an illustration of an example synthetic data generation system suitable for use in implementing some embodiments of the present disclosure;

FIG. 3 is an illustration of an example flow diagram for evaluation and monitoring for a generative AI application, in accordance with some embodiments of the present disclosure;

FIG. 4 is an illustration of an example flow diagram for regression detection for a generative AI application, in accordance with some embodiments of the present disclosure;

FIG. 5A is a block diagram of an example generative language model system suitable for use in implementing at least some embodiments of the present disclosure;

FIG. 5B is a block diagram of an example generative language model that includes a transformer encoder-decoder suitable for use in implementing at least some embodiments of the present disclosure;

FIG. 5C is a block diagram of an example generative language model that includes a decoder-only transformer architecture suitable for use in implementing at least some embodiments of the present disclosure;

FIG. 6 is a block diagram of an example computing device suitable for use in implementing at least some embodiments of the present disclosure; and

FIG. 7 is a block diagram of an example data center suitable for use in implementing at least some embodiments of the present disclosure.

### DETAILED DESCRIPTION

Systems and methods are disclosed related to automatic evaluation, monitoring, and root cause analysis for generative AI applications. Current techniques for evaluating the performance of generative AI applications during preproduction and production phases are typically manual. The evaluation process may involve developers performing local debugging sessions and using ground truth datasets to assess and improve output quality of the generative AI application. This manual process is time-consuming, inefficient, and prone to human error. Some current techniques may automatically generate and provide metrics indicative of the quality (e.g., relevance, faithfulness, etc.) of the final output for generative AI applications. While these metrics may indicate to the developer whether the generative AI application is ready for production, they do not provide enough information to enable tuning or adapting the components of the generative AI application when performance is inadequate or there is a regression in performance. Further, as generative AI applications are updated and/or new data is ingested into databases (e.g., in RAG systems), the currently automated techniques do not provide sufficient capabilities to ensure consistent performance.

In contrast to conventional systems, such as those described above, the systems and methods presented in this disclosure use evaluation and monitoring techniques that provide comprehensive and actionable evaluation for improving or maintaining performance of a generative AI application. The evaluation and monitoring of the generative AI application may include generating quality metric(s) for the outputs produced by the generative AI application and logging data flow, processing steps, and performance metric(s) associated with the generative AI application. One or more models may be used to perform root cause analysis and generate one or more indications of a root cause of a regression for the generative AI application based at least on the quality metric(s) and log(s). In some embodiments, the evaluation and monitoring may further include receiving recent configuration changes (e.g., to the source code, parameters, settings, etc.) made for the generative AI application, and the root cause analysis generated using the model(s) may provide further insight and actionable steps for addressing a regression for the generative AI application based on the configuration changes. The techniques described herein may be used to more efficiently and accurately evaluate generative AI applications in a pre-production environment and ensure that the generative AI applications have consistent and satisfactory performed in production environments.

An evaluation and monitoring system as described herein may be utilized to evaluate and monitor one or more generative AI applications. The evaluation and monitoring system to evaluate and monitor generative AI application(s) may be implemented using one or more microservices. The evaluation and monitoring system may include an evaluator function that may generate quality metric(s) and a logging function that may capture information about data flow, processing steps, and performance metric(s) associated with the generative AI application during evaluation of a generative AI application. The evaluation and monitoring system may also include a root cause analysis function that may analyze the quality metric(s), data flow, processing steps, and performance metric(s) to identify the source of issues with the generative AI application(s). The generative AI applications may include, but are not limited to, large language model(s) (LLM(s)), RAG application(s) (e.g., RAG chatbot(s)), or other types of generative AI applications. Embodiments of a generative AI application discussed herein may particularly refer to features of a RAG application that includes using LLM(s), but it should be understood that the techniques for evaluation and monitoring may be used for other types of generative AI applications as well.

An evaluation for the generative AI application may be triggered in a number of different ways that may be configurable by a user of the system. The evaluation may be manually triggered by a user via a user interface (e.g., a web user interface). In addition to, or instead of, manually triggering the evaluation, the evaluation may be triggered automatically according to a schedule (e.g., Cron Job, etc.) or in response to a triggering event. For example, the evaluation may be triggered in response to a change in the configuration for the generative AI application being evaluated (e.g., if the evaluation and monitoring system is linked to the source code management (SCM) tool for the generative AI application and the source code changes).

One or more testing datasets may be retrieved from a data store for use in the evaluation of the generative AI application. The testing dataset(s) may correspond to a specific subject matter for the generative AI application and may be curated by a subject matter expert (SME) upon request by a developer of the generative AI application. In some embodiments, the testing dataset(s) may be synthetically generated (e.g., using language model(s) based on system prompt(s) and data that has been ingested for the generative AI application). For example, for a RAG application, vector database(s) may contain data that the RAG application will retrieve during operation, and the synthetic data for the testing dataset(s) may be generated based on the data from the vector database(s). The testing dataset(s) may include, but are not limited to, test queries and ground truth responses corresponding to data from FAQs, system diagrams, or other sources pertinent to the RAG application.

The test queries may be run through the generative AI application, and the generative AI application will provide responses based on the test queries. One or more techniques for evaluating the quality of the responses generated by the generative AI application may be applied. For example, the evaluator function may generate one or more quality metrics based on the test queries and ground truth responses, and the quality metric(s) may be indicative of the quality of the output of the generative AI application compared to the ground truth responses. The quality metric(s) may include, but are not limited to, Bilingual Evaluation Understudy (BLEU), Recall-Oriented Understudy for Gisting Evaluation (ROUGE), and/or Bidirectional Encoder Representations from Transformers Score (BERTScore). In some embodiments, custom metrics may be defined and used to evaluate the quality of the outputs of the generative AI application for particular domains or use cases.

In addition to, or instead of, the quality metric(s) discussed above, LLM-as-a-judge techniques may be used to evaluate the quality of the responses output by the generative AI application in response to the test queries. For example, one or more system prompts may be used to assign a LLM to evaluate the responses output by the generative AI application in response to the test queries and generate one or more quality metrics, which may include, but are not limited to, metrics indicative of correctness, helpfulness, conciseness, veracity, and/or empathy. The system prompt(s) provided for LLM-as-a-judge may be customized based on the testing dataset(s), subject matter, level of citation and support to be provided, and other criteria depending on the desired operation of the generative AI application. The output of the LLM-as-a-judge techniques may include the quality metrics indicative of correctness, helpfulness, and/or empathy.

The various quality metrics may be stored (e.g., in a data store) for use by one or more components of the evaluation and monitoring system. In some embodiments, the various quality metrics may be combined (e.g., using weighting) to generate a combined or overall quality score for the response output by the generative AI application in response to the test query. The quality metrics may be sent to a monitoring dashboard that may be viewed by a developer using the evaluation and monitoring system (e.g., via a user interface).

While the quality metric(s) discussed above are determined based on the output(s) of the generative AI application and are indicative of the performance of the generative AI application as a whole, it may be desirable to evaluate individual components of the generative AI application to enable more specific analysis and performance enhancements. In some embodiments, one or more retrievers for a generative AI application (e.g., a RAG application) may be evaluated and specific metrics for the retriever(s) are generated based on the operation of the retriever(s) using one or more testing datasets (e.g., synthetically generated testing datasets). The specific metrics for the retriever(s) may include, but are not limited to, recall at k, precision at k, mean reciprocal rank (MRR), and/or other evaluation metrics for retrieval. The specific metrics for the retriever(s) and/or other components of the generative AI application may be stored, combined, and/or sent to a monitoring dashboard in a manner similar to that described above.

One or more logs of data flow and processing steps for one or more components of the generative AI application may be generated during the evaluation. The logs of the data flow and processing steps may be generated on a per-query basis. The data flow and processing steps may be related to retrieval, model generation, post-processing, and other operations for the components of the generative AI application. For example, the logs of the data flow and processing steps may capture traces (e.g., LLM traces and/or application traces) among other types of information. In some embodiments, the logging function may implement callbacks to obtain information regarding the data flow and processing steps. The callbacks may be customized to tailor the information regarding the data flow and processing steps and implement security settings (e.g., to limit personally identifiable information gathering). The logs may also include one or more performance metrics associated with operation of the generative AI application during the evaluation. For example, the performance metric(s) may include, but are not limited to, response times (e.g., latency, P95, P99, etc.), context alignment scores, and retrieval relevancy indicators.

The quality metric(s) and/or the log(s) may be used to detect a regression for the generative AI application. For example, a regression may be detected when one or more of the quality metric(s) and/or the performance metric(s) fall outside a threshold range, which may be configurable by a user based on specific requirements for the system. In some embodiments, a regression may be detected based on a comparison between current metric(s) and historical metrics for the generative AI application. The current metric(s) may be associated with a current configuration of the generative AI application, and the historical metrics may be associated with one or more past configurations of the generative AI application. A regression may be detected, for example, if the current metric(s) are lower than the historical metrics and/or deviate from a trend of historical metrics. When a regression is detected for the quality metric(s) and/or the performance metric(s), one or more alerts may be triggered and notice may be sent to a monitoring dashboard that may be viewed by a developer using the evaluation and monitoring system (e.g., via a user interface).

One or more models may receive the quality metric(s) and/or the log(s) for the component(s) of the generative AI application as input. In some embodiments, the model(s) may receive configuration information for the generative AI application, which may include source code, parameter(s), and/or setting(s) for one or more components of the generative AI application in addition to the quality metric(s) and the log(s). The model(s) may generate one or more indications of a root cause of the regression for the generative AI application based at least on the quality metrics and/or the log(s) (e.g., data flow, processing steps, and/or performance metric(s)). The model(s) may also generate the indication(s) of the root cause based on the configuration information in addition to quality metric(s) and/or the log(s) depending on the circumstances.

The model(s) may perform a root cause analysis based on one or more system prompts assigning one or more tasks to the model(s). For example, the model(s) may perform pattern recognition and anomaly detection across the metric(s) and/or logged data to identify specific components (e.g., retrieval, model response generation, etc.) of the generative AI application that may be contributing to performance deviations or quality issues. The model(s) may categorize potential root causes of the regression (e.g., as data drift, retrieval inconsistencies, alignment mismatches, etc.). The model(s) may include one or more machine learning models (e.g., LLM(s)) and may implement LLM-as-a-judge, Mixture of Experts (MoE), and/or other techniques to perform at least a portion of the root cause analysis.

One or more operations for addressing the regression for the generative AI application may be performed based on the indication(s) of the root cause of the regression for the generative AI application. The operation(s) may include generating one or more reports that identify the root cause of the regression (e.g., for the quality metric(s) and/or the performance metric(s)) for the generative AI application. The report(s) may also identify one or more portions of source code, one or more parameters, and/or one or more settings for the generative AI application that are relevant to the regression for the generative AI application. For example, the report(s) may provide reference to the specific component(s) of the generative AI application relevant to the root cause of the regression and the source code, parameters, and/or settings for those specific component(s). The report(s) may include one or more proposed actions to address the regression for the generative AI application, which may include, but are not limited to, proposed actions to provide links in the response for support, review particular portions of the log(s), adapt the source code, adapt the parameter(s), adapt the setting(s), or other actions. The report(s) may also summarize the root cause analysis performed by the model(s) and/or summarize improvements/regressions/trending for the metric(s) to provide further context for the indication of the root cause of the regression and proposed actions to address the regression for the generative AI application. The report(s) may be sent to a variety of channels (e.g., messaging, email, etc.) to ensure the developer(s) are aware of trends and longer-term issues.

Embodiments presented in the disclosure primarily refer to RAG applications. However, it should be understood that techniques similar to those described herein may be used for other types of generative AI applications. Further, while the indication(s) of the root cause are described herein as pertaining to a regression for the generative AI application, it should be understood that the indication(s) of the root cause may pertain to improvements as well such that the developer(s) may better understand why improved metrics were observed.

Although examples may be described herein with respect to using machine learning models, such as neural networks or diffusion models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), etc.), and/or other types of machine learning models.

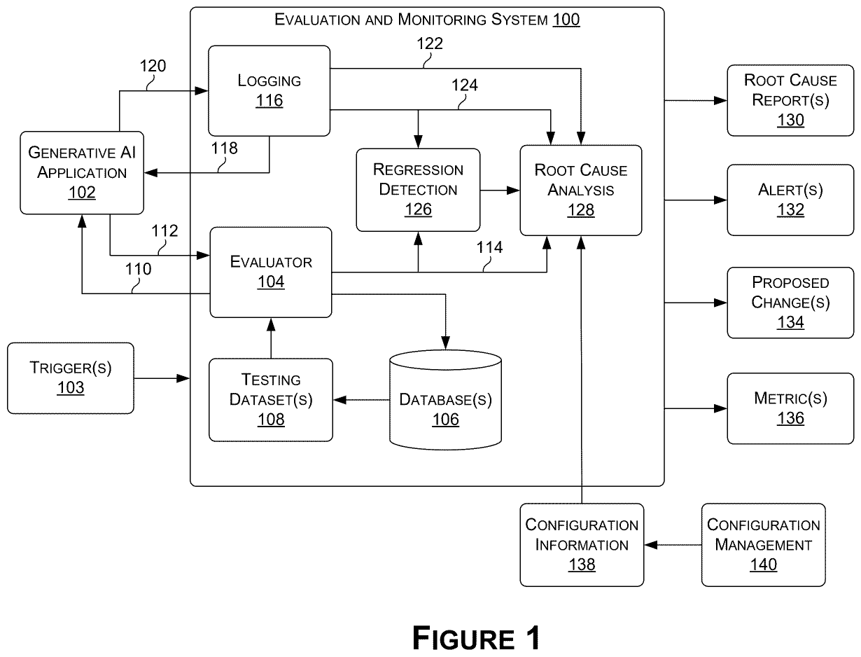

With reference to FIG. 1, FIG. 1 is an example data flow diagram illustrating the interconnection of components and flow of information of data for an evaluation and monitoring system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The evaluation and monitoring system 100 may be used to evaluate and monitor the generative AI application 102. In the example shown in FIG. 1, the evaluation and monitoring system 100 may include an evaluator function 104, a logging function 116, a regression detection function 126, and a root cause analysis function 128. While a single generative AI application 102 is shown in FIG. 1, it should be understood that the evaluation and monitoring system 100 may be used to evaluate and monitor one or more generative AI applications. The generative AI application 102 may include, but are not limited to, generative language model(s) (e.g., generative language model system 500), RAG application(s) (e.g., RAG chatbot(s)), or other types of generative AI applications. Embodiments of a generative AI application discussed herein may particularly refer to features of a RAG application that includes using LLM(s), but it should be understood that the techniques for evaluation and monitoring may be used for other types of generative AI applications as well.

The evaluation and monitoring system 100 may receive one or more triggers 103 that may trigger the evaluation of the generative AI application 102 using the evaluation and monitoring system 100. The trigger(s) 103 may be provided manually via a user interface (e.g., a web user interface) for the evaluation and monitoring system 100 and/or automatically according to a schedule (e.g., Cron Job, etc.) or in response to an event. The trigger(s) 103 may be provided in response to a change in the configuration for the generative AI application 102. For example, the evaluation and monitoring system 100 may be linked to a configuration management tool 140 (e.g., source code management (SCM) tool, etc.) for the generative AI application 102 in some embodiments, and the trigger(s) 103 may be provided when the configuration changes for the generative AI application 102.

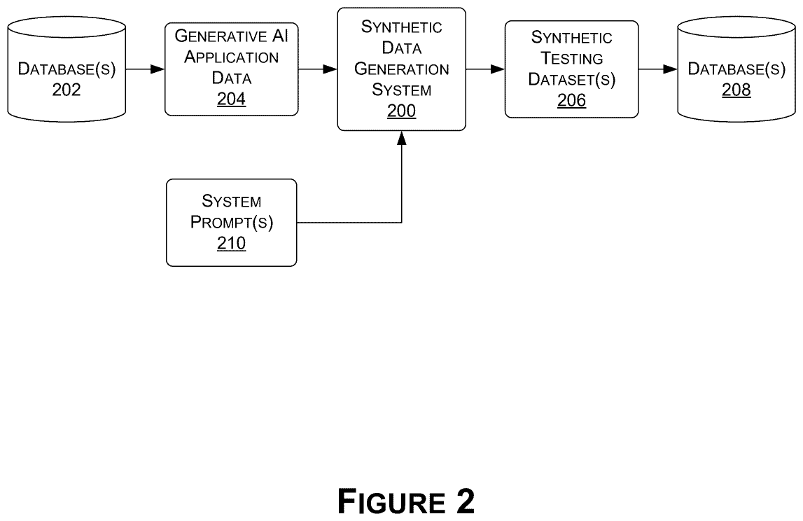

The evaluator function 104 may retrieve one or more testing datasets 108 from database(s) 106 for use in evaluating the generative AI application 102. The database(s) 106 may be a repository for testing data that may be specific to the type of application implemented by the generative AI application 102. The testing dataset(s) 108 may correspond to specific subject matter for the generative AI application 102. The testing dataset(s) 108 may be curated by a subject matter expert (SME) upon request by a developer of the generative AI application. In some embodiments, the one or more testing datasets testing dataset(s) 108 may be synthetically generated (e.g., as discussed below with respect to FIG. 2). The testing dataset(s) 108 may include test queries and ground truth responses corresponding to FAQs, system diagrams, and/or other sources used by the generative AI application 102.

The evaluator function 104 may provide one or more test queries 110 to the generative AI application 102, and the generative AI application 102 may generate one or more responses 112 that may be provided to the evaluator function 104. The evaluator function 104 may apply one or more techniques for evaluating the response(s) 112 generated by the generative AI application 102. In some embodiments, the evaluator function 104 may generate one or more quality metrics 114 based on the one or more test queries 110 and ground truth responses corresponding to the one or more test queries 110 and the response(s) 112. The quality metric(s) 114 may be indicative of a quality of the response(s) 112 output by the generative AI application 102 compared to the ground truth responses for the corresponding one or more test queries 110. The quality metric(s) 114 may include, but are not limited to, BLEU, ROUGE, and/or BERTScore. Custom metrics may also be defined and used to evaluate the quality of the response(s) 112 generated and output by the generative AI application 102 for particular domains or use cases.

The evaluator function 104 may utilize LLM-as-a-judge techniques to evaluate the quality of the response(s) 112 generated and output by the generative AI application 102 in response to the one or more test queries 110. In some embodiments, the evaluator function 104 may use one or more system prompts to assign one or more LLMs to evaluate the response(s) 112 generated and output by the generative AI application 102 in response to the one or more test queries 110. In some embodiments, the one or more LLMS may be provided the one or more test queries 110, the response(s) 112, and the ground truth responses as part of the system prompt. The one or more LLMs may generate one or more quality metrics, which may include, but are not limited to, metrics indicative of correctness, helpfulness, conciseness, veracity, and/or empathy. The system prompts provided for LLM-as-a-judge techniques may be customized based on the testing dataset(s) 108, the subject matter, a level of citation and support to be provided, and/or other criteria depending on the desired operation of the generative AI application 102.

In the example shown in FIG. 1, the evaluator function 104 may output the quality metric(s) 114 to the regression detection function 126 and the root cause analysis function 128. The quality metric(s) 114 output by the evaluator function 104 may be stored (e.g., in a data store) for use by one or more components of the evaluation and monitoring system 100 (e.g., the regression detection function 126 and/or the root cause analysis function 128). In some embodiments, the quality metric(s) 114 output by the evaluator function 104 may be combined (e.g., using weighting) to generate one or more combined or overall quality scores for the response(s) 112 generated and output by the generative AI application 102 in response to the one or more test queries 110. The quality metric(s) 114 may be sent to a monitoring dashboard that may be viewed by a developer for the generative AI application 102 via a user interface for the evaluation and monitoring system 100 (e.g., as represented by the one or more metrics 136).

In addition to, or instead of, the quality metric(s) 114 discussed above with respect to FIG. 1, which are determined based on the response(s) 112 of the generative AI application 102 and are indicative of the performance of the generative AI application 102 as a whole, the evaluator function 104 may also generate at least one quality metric 114 that is indicative of a quality of one or more outputs of a specific component of the generative AI application 102. For example, if the generative AI application 102 includes one or more retrievers, quality metric(s) 114 may be generated for the retriever(s) based on the operation of the retriever(s) using the testing dataset(s) 108. The specific metrics for the retriever(s) may include, but are not limited to, recall at k, precision at k, mean reciprocal rank (MRR), and/or other evaluation metrics for retrieval. The specific metrics for the retriever(s) and/or other metrics for individual components of the generative AI application 102 may be stored, combined, and/or sent to a monitoring dashboard for the evaluation and monitoring system 100 in a manner similar to that described above.

The logging function 116 of the evaluation and monitoring system 100 may generate one or more logs for one or more components of the generative AI application 102 generated during the evaluation. In the example shown in FIG. 1, the logging function 116 may implement callbacks 118 to obtain information regarding the data flow and processing steps 120. The callbacks 118 may be customized to tailor the information regarding the data flow and processing steps 120 and implement security settings (e.g., to limit personally identifiable information gathering). The logging function 116 may generate one or more logs 122 that may include the data flow and processing steps 120 for the component(s) of the generative AI application 102. The log(s) 122 may be generated on a per-query basis (e.g., for each of the one or more test queries 110) during the evaluation. The data flow and processing steps 120 of the log(s) 122 may be related to retrieval, model generation, post-processing, and other operations for the component(s) of the generative AI application 102. For example, the log(s) 122 of the data flow and processing steps 120 may capture traces (e.g., LLM traces and/or application traces) among other types of information for the components of the generative AI application 102. The logging function 116 may output the log(s) 122 including the data flow and processing steps 120 to the regression detection function 126 and/or the root cause analysis function 128.

The logging function 116 of the evaluation and monitoring system 100 may also generate one or more logs 124 that include one or more performance metrics associated with operation of the generative AI application 102 during the evaluation. For example, the one or more performance metrics in the log(s) 124 generated by the logging function 116 may include, but are not limited to, response times (e.g., latency, P95, P99, etc.), context alignment scores, and retrieval relevancy indicators. The logging function 116 may output the log(s) 124 including the one or more performance metrics to the regression detection function 126 and/or the root cause analysis function 128. The performance metrics in the log(s) 124 may be sent to a monitoring dashboard that may be viewed by a developer for the generative AI application 102 via a user interface for the evaluation and monitoring system 100 (e.g., as represented by the one or more metrics 136).

While the log(s) 122 including the data flow and processing steps 120 and the log(s) 124 including the one or more performance metrics are shown and described as separate logs output by the logging function 116, it should be understood that the log(s) 122 and the log(s) 124 may also be combined and output in one or more combined logs that include the data flow, processing steps, and performance metrics in some embodiments. Further, the log(s) 122 and/or the log(s) 124 output by the logging function 116 may be stored (e.g., in a data store) for use by one or more components of the evaluation and monitoring system 100 (e.g., the regression detection function 126 and/or the root cause analysis function 128).

The regression detection function 126 of the evaluation and monitoring system 100 may use the quality metric(s) 114 and/or the log(s) 124 to detect a regression for the generative AI application 102. The regression detection function 126 may determine whether the quality metric(s) 114 and/or the performance metrics in the log(s) 124 fall outside a threshold range, which may be configurable by a user (e.g., via a user interface for the evaluation and monitoring system 100) based on specific requirements for the system. In some embodiments, the regression detection function 126 may compare current metrics and historical metrics for the generative AI application 102. The current metrics may include the most recently provided quality metric(s) 114 and/or performance metrics in the log(s) 124, and the current metrics may be associated with a current configuration of the generative AI application 102. The historical metrics may include quality metric(s) 114 and/or performance metrics in the log(s) 124 provided in the past (e.g., not the most recently provided), and the historical metrics may be associated with one or more past configurations of the generative AI application 102. The historical metrics may be represented by one or more combined (e.g., averaged) metrics, trends, or other forms. The regression detection function 126 may detect a regression, for example, if the current metrics are lower than the historical metrics and/or deviate from a trend of the historical metrics. When the regression detection function 126 detects a regression for the generative AI application 102, the regression detection function 126 may output one or more alerts 132 may be triggered and provided to a monitoring dashboard that may be viewed by a developer using the evaluation and monitoring system 100 (e.g., via a user interface). The regression detection function 126 may also provide an indication of the detected regression for the generative AI application 102 to the root cause analysis function 128.

The root cause analysis function 128 of the evaluation and monitoring system 100 may receive the quality metric(s) 114, the log(s) 122, and the log(s) 124 as input. In some embodiments, the root cause analysis function 128 may also receive configuration information 138, which may be provided by the configuration management tool 140 or another source. The configuration information 138 may include, but is not limited to, source code, one or more parameters, and/or one or more settings for one or more components of the generative AI application 102. The configuration information 138 may also include an indication of differences between configurations of the generative AI application 102. For example, the configuration information 138 may include an indication of differences (e.g., for source code, parameter(s), and/or setting(s)) between a current configuration of the generative AI application 102 and the next more recent configuration of the generative AI application 102. The root cause analysis function 128 may be implemented using one or more models, which may include one or more machine learning models (e.g., LLM(s) or other generative LM(s)) and may implement LLM-as-a-judge, Mixture of Experts (MoE), and/or other techniques to perform at least a portion of the root cause analysis.

The model(s) of the root cause analysis function 128 may generate one or more indications of a root cause of the regression for the generative AI application 102 based on the quality metric(s) 114, the log(s) 122 and/or the log(s) 124. The model(s) of the root cause analysis function 128 may also generate the one or more indications of the root cause of the regression for the generative AI application 102 based on the configuration information 138 in addition to the quality metric(s) 114, the log(s) 122, and/or the log(s) 124. The model(s) of the root cause analysis function 128 may perform a root cause analysis based on one or more system prompts assigning one or more tasks to the model(s). For example, the model(s) of the root cause analysis function 128 may perform pattern recognition and anomaly detection across the quality metric(s) 114, the data flow and processing steps 120 of the log(s) 122, and/or the performance metrics of the log(s) 124 to identify specific components (e.g., retrieval, model response generation, etc.) of the generative AI application 102 that may be contributing to performance deviations or quality issues. The model(s) of the root cause analysis function 128 may categorize potential root causes of the regression (e.g., as data drift, retrieval inconsistencies, alignment mismatches, etc.).

The evaluation and monitoring system 100 may also perform one or more operations for addressing the regression for the generative AI application 102 based on the one or more indications of the root cause generated by the model(s) of the root cause analysis function 128. The one or more operations may include generating one or more reports 130 that identify the root cause of the regression (e.g., of the quality metric(s) 114 and/or the performance metrics of the log(s) 124) for the generative AI application 102. The report(s) 130 may also identify one or more portions of source code, one or more parameters, and/or one or more settings for the generative AI application 102 that are relevant to the regression for the generative AI application 102. For example, the report(s) 130 may provide reference to the specific component(s) of the generative AI application 102 relevant to the root cause of the regression and the source code, parameters, and/or settings for those specific component(s). The report(s) 130 may include one or more proposed actions to address the regression for the generative AI application 102, which may include, but are not limited to, proposed actions to provide links in the one or more test queries 110 for support, review particular portions of the log(s) 122, adapt the source code, adapt the parameter(s), adapt the setting(s), or other actions. The report(s) 130 may also summarize the root cause analysis performed by the model(s) of the root cause analysis function 128 and/or summarize improvements/regressions/trending for the quality metric(s) 114 and/or the performance metrics in the log(s) 124 to provide further context for the indication of the root cause of the regression and proposed actions to address the regression for the generative AI application 102. The report(s) 130 may be sent to a variety of channels (e.g., messaging, email, etc.) to ensure the developer(s) for the generative AI application 102 are aware of trends and longer-term issues.

The one or more operations performed by the evaluation and monitoring system 100 may include generating one or more proposed changes 134 to a configuration for the generative AI application 102. For example, the evaluation and monitoring system 100 may include a configuration generation component that may generate one or more proposed changes to the source code, the parameter(s), and/or the setting(s) for one or more components of the generative AI application 102. The evaluation and monitoring system 100 may generate the proposed changes based on the information in the report(s) 130 and the configuration information 138.

Now referring to FIG. 2, FIG. 2 is an example data flow diagram illustrating the interconnection of components and flow of information of data for a synthetic data generation system 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

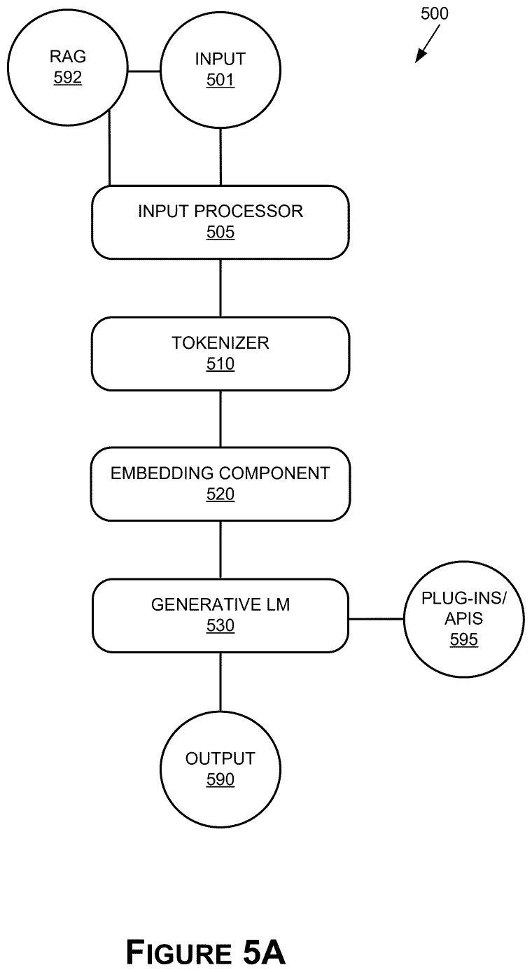

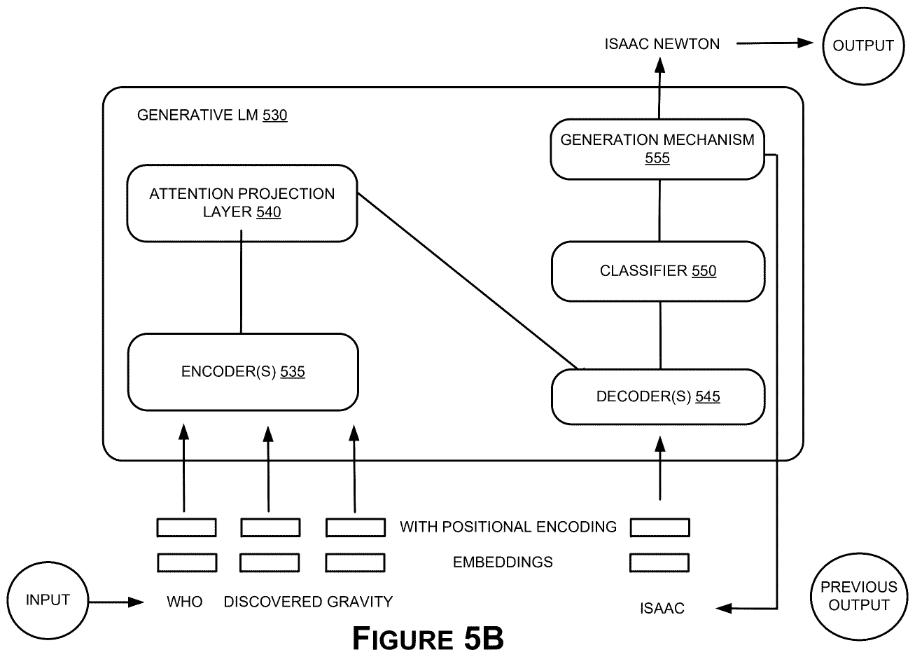

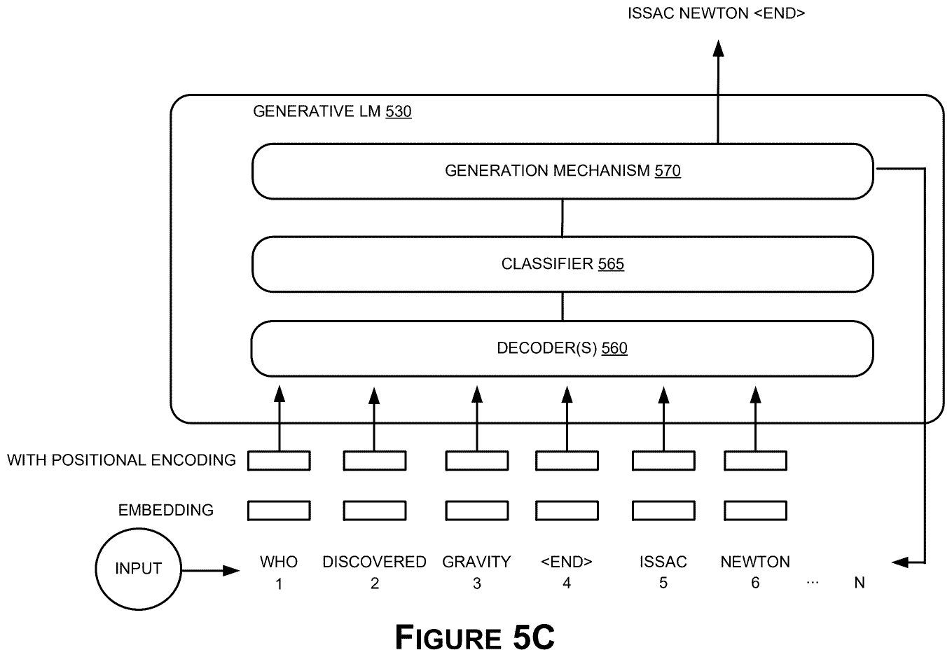

The synthetic data generation system 200 may include one or more models that may generate synthetic testing dataset(s) 206. The model(s) may include one or more machine learning models (e.g., LLM(s) or other generative LM(s)) and may generate the synthetic testing dataset(s) 206 based on generative AI application data 204 received from database(s) 202 using one or more generative techniques (e.g., as discussed with respect to FIGS. 5A-5C). The database(s) 202 may be used to store generative AI application data 204 that the generative AI application 102 being evaluated ingests for at least some of its functionality. The generative AI application data 204 may include FAQs, system diagrams, or other sources utilized by the generative AI application 102 during operation (e.g., when generating response(s) 112). For example, the generative AI application 102 may retrieve at least some of the generative AI application data 204 as context when generating the response(s) 112 in response to the one or more test queries 110 or when generating response(s) to one or more user queries during deployment in production. The database(s) 202 may comprise a vector database or other type of database utilized by generative AI applications.

The synthetic data generation system 200 may also receive system prompts 210 in addition to the generative AI application data 204 from the database(s) 202. The system prompts 210 may be used to direct the generation of the synthetic testing dataset(s) 206 by the model(s) of the synthetic data generation system 200. For example, the system prompts 210 may instruct the model(s) of the synthetic data generation system 200 to generate test queries (e.g., one or more test queries 110) and ground truth responses corresponding to the test queries. For some types of the generative AI application data 204 (e.g., FAQs), the system prompts 210 used for producing the test queries and corresponding ground truth responses may be fairly straightforward. The system prompts 210 may instruct the model(s) of the synthetic data generation system 200 to use the questions as the test queries and the answers as the ground truth responses and/or to generate variations of the questions and responses for the test queries and ground truth responses, respectively. For less structured generative AI application data 204 (e.g., system diagrams), the system prompts 210 may be curated through trial and error to produce desired results for generating proper test queries and ground truth responses from the generative AI application data 204, and a user of the synthetic data generation system 200 may use these predetermined system prompts.

The synthetic testing dataset(s) 206 generated by the synthetic data generation system 200 may be output to database(s) 208 for future use by one or more components of the evaluation and monitoring system 100. In some embodiments, the synthetic testing dataset(s) 206 form at least some of the testing dataset(s) 108 provided to the evaluator function 104 of the evaluation and monitoring system 100. The database(s) 208 may be separate from the database(s) 106 of the evaluation and monitoring system 100, and the synthetic testing dataset(s) 206 may be provided to the database(s) 106 from the database(s) 208. In some embodiments, the database(s) 208 may be part of the database(s) 106 of the evaluation and monitoring system 100.

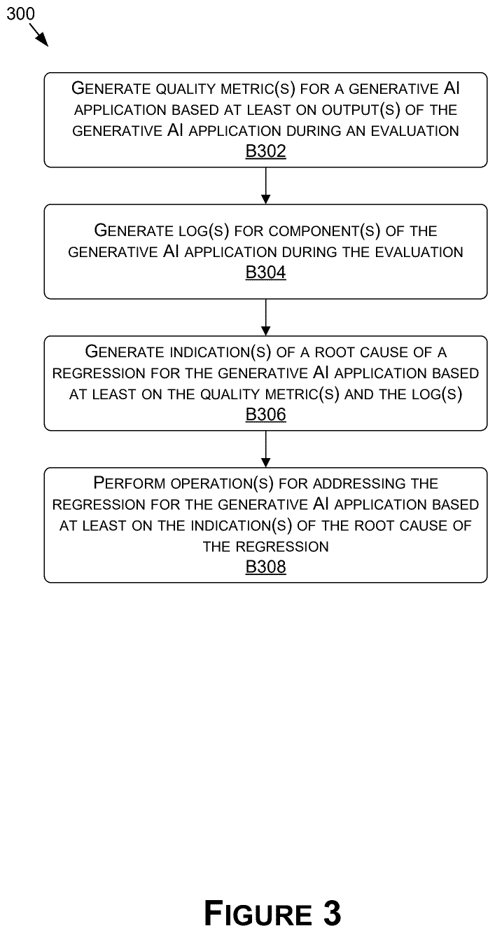

Now referring to FIG. 3, FIG. 3 is a flow diagram showing an example method 300 for evaluation, monitoring, and root cause analysis for a generative AI application, in accordance with some embodiments of the present disclosure. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

The method 300, at block B302, includes generating one or more quality metrics for a generative AI application based at least on one or more outputs of the generative AI application during an evaluation. The evaluation for the generative AI application (e.g., the generative AI application 102) may be manually triggered (e.g., by a user via a user interface) or automatically triggered (e.g., according to a schedule or in response to a triggering event). The evaluation may comprise running test queries from testing dataset(s) through the generative AI application and evaluating the response that is output by the generative AI application to generate the quality metric(s).

The quality metric(s) for the generative AI application may be indicative of a quality of the output(s) by the generative AI application in response to one or more test queries. In some embodiments, the quality metric(s) may be determined based on a comparison of the output(s) by the generative AI application to a ground truth response(s) corresponding to the one or more test queries. The quality metric(s) may include, but are not limited to, BLEU, ROUGE, and/or BERTScore. The quality metric(s) may be determined using one or more LLM-as-a-judge techniques, and the quality metric(s) may be indicative of correctness, helpfulness, conciseness, veracity, and/or empathy of the output(s) by the generative AI application. In addition to overall or comprehensive quality metric(s) that are indicative of a quality of the generative AI application as a whole, quality metric(s) specific to one or more components of the generative AI application may also be determined.

The method 300, at block B304, includes generating one or more logs for one or more components of the generative AI application during the evaluation. The log(s) for the component(s) of the generative AI application may be generated on a per-query basis during the evaluation. The log(s) for the component(s) of the generative AI application may comprise data flow and processing steps related to retrieval, model generation, post-processing, and other operations for the components of the generative AI application. The log(s) may capture traces (e.g., LLM traces and/or application traces) and be implemented, at least in part, based on callbacks. In some embodiments, the callbacks may be customized to limit personally identifiable information gathering or implement other security related features. The logs may also include one or more performance metrics associated with operation of the generative AI application during the evaluation. For example, the performance metric(s) may include, but are not limited to, response times (e.g., latency, P95, P99, etc.), context alignment scores, and retrieval relevancy indicators.

The method 300, at block B306, includes generating one or more indications of a root cause of a regression for the generative AI application based at least on the one or more quality metrics and the one or more logs. The indication(s) of the root cause of the regression for the generative AI application may be generated using one or more machine learning models (e.g., LLMs or other generative LMs) based on system prompt(s) assigning task(s) to the machine learning model(s). The indication(s) of the root cause may be generated using pattern recognition and anomaly detection across the quality metric(s) and/or the log(s) (e.g., data flow, processing steps, and/or the performance metrics) to identify specific components (e.g., retrieval, model response generation, etc.) of the generative AI application that may be contributing to performance deviations or quality issues. The indication(s) of the root cause may be categorized (e.g., as data drift, retrieval inconsistencies, alignment mismatches, etc.). In some embodiments, configuration information (e.g., source code, parameter(s), and/or setting(s) for one or more components of the generative AI application) may be available and used to generate the indication(s) of the root cause of the regression for the generative AI application in addition to the quality metric(s) and/or the log(s).

The method 300, at block B308, includes performing one or more operations for addressing the regression for the generative AI application based at least on the one or more indications of the root cause of the regression. The operation(s) for addressing the regression for the generative AI application may include generating and outputting reports identifying the root cause of the regression and providing one or more proposed actions to address the regression. The reports may identify the specific component(s) of the generative AI application relevant to the root cause of the regression and the source code, parameters, and/or settings for those specific component(s). The proposed action(s) to address the regression for the generative AI application may include, but are not limited to, proposed actions to provide links in the response for support, review particular portions of the log(s), adapt the source code, adapt the parameter(s), adapt the setting(s), or other actions. In some embodiments, the operation(s) for addressing the regression for the generative AI application may also include generating and outputting one or more proposed changes to a configuration for the generative AI application. For example, proposed change(s) to the source code, parameter(s), and/or the setting(s) for the specific component(s) of the generative AI application relevant to the root cause of the regression may be generated based on the quality metric(s), log(s), and configuration information (e.g., based on a difference between configurations).

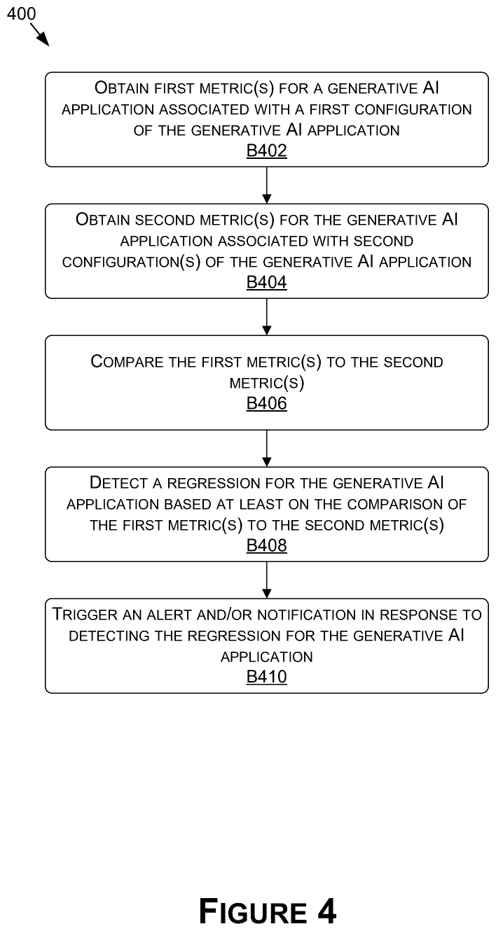

Now referring to FIG. 4, FIG. 4 is a flow diagram showing an example method 400 for regression detection, in accordance with some embodiments of the present disclosure. Each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

The method 400, at block B402, includes obtaining one or more first metrics for a generative AI application associated with a first configuration of the generative AI application. The first metric(s) may include quality metric(s) and/or performance metrics for the generative AI application that are associated with the first configuration of the generative AI application. The first configuration of the generative AI application may correspond to a current or most recent configuration of the generative AI application that has been evaluated. For example, the first configuration for the generative AI application may include, but is not limited to, source code, parameter(s), and/or setting(s) for the current or most recent configuration of the generative AI application that has been evaluated. The quality metric(s) of the first metric(s) may include, but are not limited to, BLEU, ROUGE, BERTScore, and/or LLM-as-a-judge metric(s) (e.g., indicative of correctness, helpfulness, conciseness, veracity, and/or empathy) for the output(s) by the generative AI application having the first configuration. The performance metric(s) may include, but are not limited to, response times (e.g., latency, P95, P99, etc.), context alignment scores, and retrieval relevancy indicators for the generative AI application having the first configuration.

The method 400, at block B404, includes obtaining one or more second metrics for the generative AI application associated with one or more second configurations of the generative AI application. The second metric(s) may include quality metric(s) and/or performance metrics for the generative AI application that are associated with a single second configuration of the generative AI application or that are associated with multiple second configurations of the generative AI application. The second configuration(s) of the generative AI application may correspond to historical configuration(s) of the generative AI application that have been evaluated. For example, the second configuration(s) for the generative AI application may include, but are not limited to, source code, parameter(s), and/or setting(s) for the historical configuration(s) of the generative AI application that have been evaluated. The second metric(s) obtained for the generative AI application having the second configuration(s) may include the same types of quality metric(s) and/or performance metric(s) as the first metric(s) obtained for the generative AI application having the first configuration.

The method 400, at block B406, includes comparing the one or more first metrics to the one or more second metrics. The comparison of the first metric(s) to the second metric(s) may include determining whether the first metric(s) are indicative of better performance than the second metric(s). The comparison of the first metric(s) to the second metric(s) may include determining a difference between the value for the first metric(s) and the value for the second metric(s). Where a single second configuration is considered, the comparison may include a direct comparison of the individual second metric(s) to corresponding first metric(s). Where multiple second configurations are considered, the comparison may include combining corresponding second metric(s) for the different second configurations in some manner. For example, the corresponding second metric(s) may be averaged to generate an average second metric for comparison to the corresponding first metric. The first metric(s) may also be compared to a trend for the corresponding second metric(s) for the different second configurations.

The method 400, at block B408, includes detecting a regression for the generative AI application based at least on the comparison of the one or more first metrics and the one or more second metrics. A regression for the generative AI application may be detected in response to the first metric(s) being indicative of worse performance than the second metric(s). That is, if there is a drop in performance for the first configuration (e.g., current configuration) of the generative AI application, then this indicates a regression for the generative AI application. A regression for the generative AI application may also be detected in response to the difference between the first metric(s) and the second metric(s) exceeding a threshold, which may be configurable by a user. Further, if the first metric(s) deviate from a trend of the second metric(s) (e.g., a stable level of operation) over a few historical configurations, then this may indicate a regression for the generative AI application.

The method 400, at block B410, includes triggering an alert and/or notification in response to detecting the regression for the generative AI application. The alert and/or notification may be provided to a monitoring dashboard that may be viewed by a developer for the generative AI application. The dashboard may be accessible via a user interface (e.g., a web user interface). The first metric(s) and second metric(s) corresponding to the regression may be provided as part of the alert and/or notification or as a supplement to the content of the alert and/or notification. The alert and/or notification may be provided via one or more other channels in addition to, or instead of, the monitoring dashboard. For example, the alert and/or notification may be provided via messaging, email, or other channels to ensure the developer(s) for the generative AI application are made aware of the regression.

In some examples, the machine learning model(s) (e.g., deep neural networks, language models, LLMs, SLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein (e.g., component(s) of the evaluation and monitoring system 100) may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models (MMLMs), etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. In some embodiments, one or more functions of the evaluation and monitoring system 100, the generative AI application 102, and/or the synthetic data generation system 200 described herein may be implemented, at least in part, using language models. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5A is a block diagram of an example generative language model system 500 suitable for use in implementing at least some embodiments of the present disclosure. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a SLM, a VLM, a multi-modal LM, etc.). In some embodiments, one or more functions of the evaluation and monitoring system 100, the generative AI application 102, and/or the synthetic data generation system 200 described herein may be implemented using features similar to those of the generative language model system 500.

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 530 (e.g., LLM/SLM/VLM/MMLM/etc.). In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 may combine text (or may omit text) with image data, audio data, video data, design data, USD data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 may remove stopwords to reduce noise and focus the generative LM 530 on more meaningful content. The input processor 505 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 592 (which may include one or more RAG models, and/or may be performed using the generative LM 530 itself) may be used to retrieve additional information to be used as part of the input 501 or prompt. RAG may be used to enhance the input to the LLM/SLM/VLM/MMLM/etc. with external knowledge, so that answers to specific questions or queries or requests are more relevant—such as in a case where specific knowledge is required. The RAG component 592 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The RAG component 592 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 592 and the embeddings of the chunks along with the embeddings of the query may be compared to identify the most similar/related embeddings to the query, which may be supplied to the generative LM 530 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 592 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 510 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 may resize the data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 505 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 505 may extract frames or apply resizing to extracted frames, and the embedding component 520 may extract features such as optical flow embeddings or video embeddings and/or may encode temporal information or sequences of frames. In some implementations in which the input 501 includes multi-modal data, the embedding component 520 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. For example, assume input text such as “Who discovered gravity” is tokenized (e.g., by the tokenizer510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 540 may convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 may generate a first token, and the generation mechanism 555 may apply the generated token as an input during a second pass. The process may repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 may output some decoded (e.g., vector) representation of the input being applied during a particular pass. The classifier 550 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 may select or sample a word or token based on a corresponding predicted probability (e.g., select the word with the highest predicted probability) and append it to the output from a previous pass, generating each word or token sequentially. The generation mechanism 555 may repeat the process, triggering successive decoder inputs and corresponding predictions until selecting or sampling a symbol or token that represents the end of the response, at which point, the generation mechanism 555 may output the generated response.

FIG. 5C is a block diagram of an example implementation in which the generative LM 530 includes a decoder-only transformer architecture. For example, the decoder(s) 560 of FIG. 5C may operate similarly as the decoder(s) 545 of FIG. 5B except each of the decoder(s) 560 of FIG. 5C omits the encoder-decoder self-attention layer (since there is no encoder in this implementation). As such, the decoder(s) 560 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 560. As with the decoder(s) 545 of FIG. 5B, each token (e.g., word) may flow through a separate path in the decoder(s) 560, and the decoder(s) 560, a classifier 565, and a generation mechanism 570 may use auto-regression to sequentially generate one token at a time until predicting a symbol or token that represents the end of the response. The classifier 565 and the generation mechanism 570 may operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

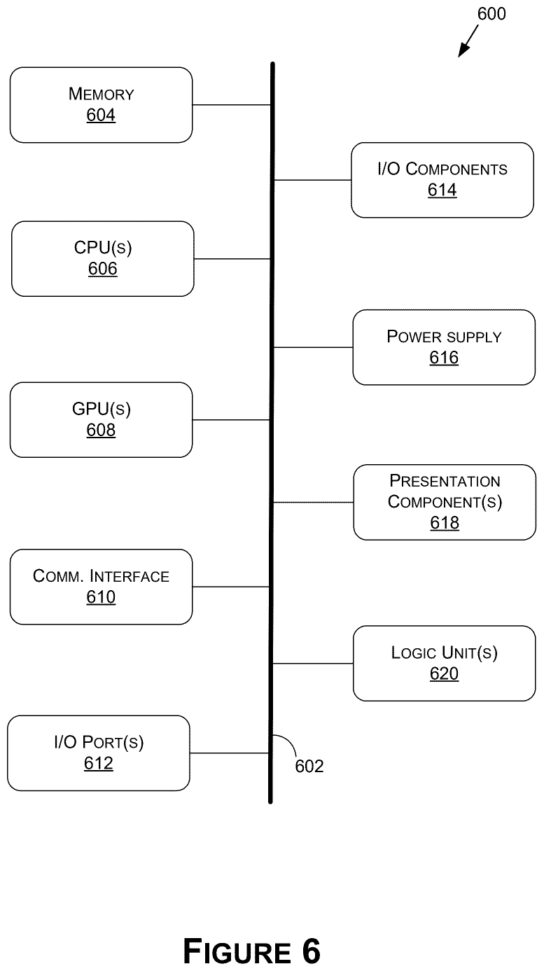

FIG. 6 is a block diagram of an example computing device(s) 600 suitable for use in implementing some embodiments of the present disclosure. In some embodiments, one or more functions of the evaluation and monitoring system 100, the generative AI application 102, and/or the synthetic data generation system 200 described herein may be implemented, at least in part, using the computing device 600. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the evaluation and monitoring system 100, the generative AI application 102, and/or the synthetic data generation system 200 described herein may be executed, at least in part, by the CPU(s) 606 and/or GPU(s) 608.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, one or more functions of the evaluation and monitoring system 100, the generative AI application 102, and/or the synthetic data generation system 200 described herein may be executed, at least in part, by the logic unit(s) 620.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

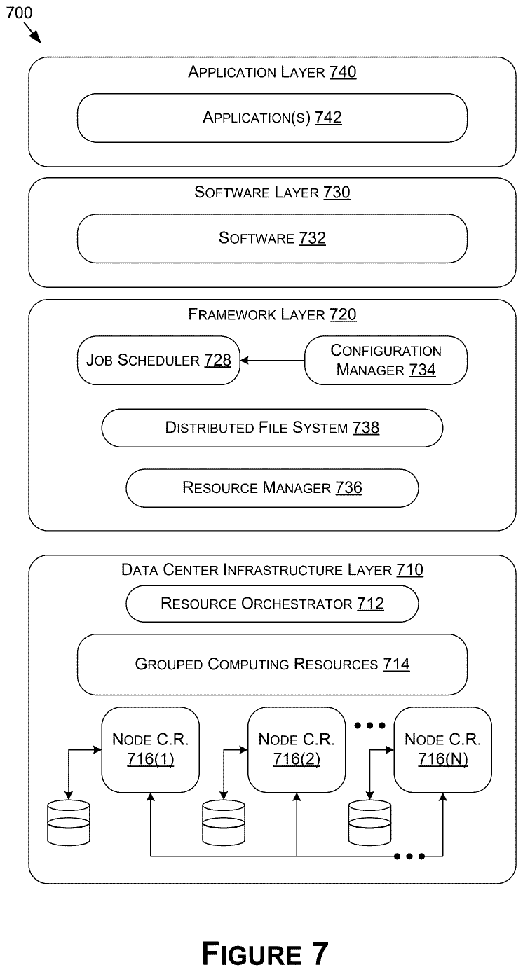

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R. s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM). In some embodiments, one or more functions of the evaluation and monitoring system 100, the generative AI application 102, and/or the synthetic data generation system 200 described herein may be implemented, at least in part, using one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
trigger an evaluation of a generative artificial intelligence (AI) application;
generate one or more quality metrics for the generative AI application during the evaluation based at least on one or more outputs of the generative AI application;
generate one or more logs for one or more components of the generative AI application during the evaluation, wherein the one or more logs for the one or more components of the generative AI application comprise data flow and processing steps executed by the one or more components of the generative AI application during the evaluation;
detect a regression for the generative AI application based at least on at least one of the one or more quality metrics for the generative AI application or the one or more logs for the one or more components of the generative AI application;
generate, using one or more models, a first output indicative of a root cause of the regression for the generative AI application based at least on at least one of the one or more quality metrics for the generative AI application or the one or more logs for the one or more components of the generative AI application; and
perform one or more operations for addressing the regression for the generative AI application based at least on the first output indicative of the root cause of the regression for the generative AI application.

2. The one or more processors of claim 1, wherein the processing circuitry is further to:
generate synthetic data based at least on data ingested for the generative AI application and one or more system prompts, wherein the synthetic data includes one or more test queries and one or more ground truth responses, wherein the evaluation comprises providing the one or more test queries to the generative AI application as input; and
generate the one or more quality metrics for the generative AI application based at least on a comparison of the one or more outputs of the generative AI application to the one or more ground truth responses.

3. The one or more processors of claim 1, wherein the processing circuitry is further to:
receive an indication of a difference between a first configuration of the generative AI application and a second configuration of the generative AI application; and
generate, using the one or more models, the first output indicative of the root cause of the regression for the generative AI application based at least on the indication of the difference between the first configuration of the generative AI application and the second configuration of the generative AI application.

4. The one or more processors of claim 1, wherein the processing circuitry is to trigger the evaluation of the generative AI application based at least on an update to source code for the generative AI application.

5. The one or more processors of claim 1, wherein the generative AI application comprises a Retrieval-Augmented Generation (RAG) application, wherein the RAG application comprises one or more retrievers and one or more large language models (LLMs).

6. The one or more processors of claim 5, wherein the evaluation of the generative AI application includes evaluating at least one of the one or more retrievers of the RAG application or the one or more LLMs, wherein the one or more quality metrics comprise at least one quality metric indicative of performance of the one or more retrievers of the RAG application or at least one quality metric indicative of performance of the one or more LLMs.

7. The one or more processors of claim 1, wherein the processing circuitry is to generate the one or more logs for the one or more components of the generative AI application during the evaluation based at least on security settings that limit personally identifiable information contained in the one or more logs for the one or more components of the generative AI application.

8. The one or more processors of claim 1, wherein the one or more operations for addressing the regression for the generative AI application comprise generating a report that comprises an identification of the root cause of the regression for the generative AI application and one or more proposed actions to address the regression for the generative AI application.

9. The one or more processors of claim 8, wherein the report further identifies one or more portions of source code, one or more parameters, or one or more settings for the generative AI application that are relevant to the regression for the generative AI application.

10. The one or more processors of claim 1, wherein the processing circuitry is further to:
compare the one or more quality metrics for the generative AI application with historical quality metrics for the generative AI application, wherein the historical quality metrics are associated with one or more past configurations of the generative AI application; and
detect the regression for the generative AI application based at least on the comparison between the one or more quality metrics for the generative AI application and the historical quality metrics for the generative AI application.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
generate one or more first quality metrics for a generative artificial intelligence (AI) application based at least on one or more outputs of the generative AI application during an evaluation of the generative AI application;
generate one or more logs for one or more components of the generative AI application during the evaluation, wherein the one or more logs for the one or more components of the generative AI application comprise data flow, processing steps, and one or more performance metrics associated with the generative AI application;
generate, using one or more models, one or more indications of a root cause of a regression for the generative AI application based at least on the one or more first quality metrics for the generative AI application and the one or more logs for the one or more components of the generative AI application; and
perform one or more operations for addressing the regression for the generative AI application based at least on the one or more indications of the root cause of the regression for the generative AI application.

13. The system of claim 12, wherein the one or more processors are further to generate the one or more logs for the one or more components of the generative AI application during the evaluation based at least on security settings that limit personally identifiable information contained in the one or more logs for the one or more components of the generative AI application.

14. The system of claim 12, wherein the one or more processors are further to compare the one or more first quality metrics to historical quality metrics to determine whether the one or more first quality metrics deviate from a historical pattern, wherein the one or more first quality metrics are associated with a first configuration of the generative AI application, wherein the historical quality metrics are associated with a second configuration of the generative AI application.

15. The system of claim 14, wherein the one or more processors are further to:
receive an indication of a difference between the first configuration of the generative AI application and the second configuration of the generative AI application; and
generate the one or more indications of the root cause of the regression for the generative AI application based at least on the indication of the difference between the first configuration of the generative AI application and the second configuration of the generative AI application.

16. The system of claim 12, wherein the generative AI application comprises a Retrieval-Augmented Generation (RAG) application, wherein the RAG application comprises one or more retrievers and one or more language models.

17. The system of claim 12, wherein the one or more processors are further to:
generate synthetic data based at least on data ingested for the generative AI application and one or more system prompts, wherein the synthetic data includes one or more test queries and one or more ground truth responses, wherein the evaluation comprises providing the one or more test queries to the generative AI application as input; and
generate the one or more first quality metrics for the generative AI application based at least on a comparison of the one or more outputs of the generative AI application to the one or more ground truth responses.

18. The system of claim 12, wherein the one or more operations comprise at least one of:
generating a report that comprises the one or more indications of the root cause of the regression for the generative AI application and one or more proposed actions to address the regression for the generative AI application;
generating a report that identifies one or more portions of source code, one or more parameters, or one or more settings for the generative AI application that are relevant to the regression for the generative AI application; or
generating one or more proposed changes to a configuration for the generative AI application.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more small language models (SLMs);
a system implementing one or more vision language models (VLMs);
a system implementing one or more multi-modal language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
performing one or more operations for addressing a regression of a generative artificial intelligence (AI) application based at least on an indication of a root cause of the regression of the generative AI application generated using one or more models based at least on one or more quality metrics for the generative AI application and one or more logs for one or more components of the generative AI application determined during an evaluation of the generative AI application, wherein the one or more quality metrics are generated based at least on a comparison of one or more outputs from the generative AI application and one or more ground truth responses, wherein the one or more logs for the one or more components of the generative AI application comprise data flow, processing steps, and one or more performance metrics associated with the generative AI application.
